(19) United States
(12) Patent Application Publication
(10) Pub. No.: US 2007/0289022 A1
(43) Pub. Date: Dec. 13, 2007

(54) Apparatus and method for the protected distribution of electronic documents

(76) Inventor: Erland Wittkotter, Hayward, CA (US)

Correspondence Address: Erland Wittkotter, Apt 174, 25200 Carlos Bee Blvd, Hayward, CA, 94542, US

(21) Appl. No.: 11/811,018

(22) Filed: Jun. 8, 2007

(30) Foreign Application Priority Data
Jun. 8, 2006 (DE) 10 2006 027 030.4

(51) Int. Cl. H04L 9/32; H04N 7/16

(52) U.S. Cl. 726/27; 726/26

(57) ABSTRACT

The invention pertains to a system for the distribution of electronic data, in which commercial opportunities for the usage of electronic documents in a distribution are protected and these opportunities are made directly available to a large number of document providers and the single consumer is not flooded by the large amount of documents, but receives server-sided hints in the form of additional data, which contains hints for the navigation and filtering of content with respect to which document is important, interesting and relevant.

### BACKGROUND OF THE INVENTION

The present invention pertains to an apparatus for the protected distribution of electronic documents in a publicly available and accessible electronic data network, in particular the Internet, as set forth in the classifying portion of claim 1. Furthermore, the present invention pertains to a method for the protected distribution of electronic documents, in particular, a method for the operation of such a system.

Digital, online distributed content, in particular audio and video content is currently more often distributed in a copyright-violating manner than in a legal, legitimate manner. In the file sharing network, a large portion of the worldwide music catalog is already free and unrestricted, accessible and available without giving artists or content owners direct or indirect compensation.

### DESCRIPTION RELATED TO STATE OF THE ART TECHNOLOGY

The commercial download of audio-/video-data is in competition with the qualitatively equivalent free content, which is in the form of uncontrollable, unprotected data formats, MP3 for audio and MPEG for video data, easily accessible via P2P networks, which creates significant, unfair disadvantages for commercial services. As a consequence, free downloads via Peer-to-Peer (P2P) networks or file sharing platforms have massively damaged the commercial offerings of digital audio and video content. Significantly contributing to this situation is the fact that large music labels have demanded that commercial solutions have mandatory user limitations on the downloaded content in the form of DRM (Digital Rights Management) restrictions.

The usage of copy protection measures or the usage of protected, in particular DRM-protected, content is for a distribution system of digital content not sufficient to survive the competition against unprotected file formats successfully. On the contrary, DRM restrictions are counterproductive. Protected formats are easy to identify via the file extension or via the used file format and could simply be avoided by file sharers. Commercial distribution models have not been able to establish themselves within the P2P networks or file sharing platforms.

In comparison with free, uncontrolled P2P networks, commercial content providers are using protected proprietary file formats, which are making use of the market power of content providers, such as labels, in order to distribute already-known content, such as songs from major label artists in order to sell them via iTunes, Napster, Yahoo, etc. The marketing of the content or informing of the customer about song availability or about new offers of an artist is done via other communication channels, in particular mass media or by means of journals, magazines, radio or television. Disadvantages of the above method are based on the free access and avoidance of complicated payment dialogs that are inherent in the more simple access to content in free P2P networks.

A known technology from the state of the art is WO 01/30080 A1, which provides a protected distribution of valuable content via P2P in an economically acceptable manner. This technology pertains to an appliance for the copy-protected distribution of electronic documents in an electronic network by means of semantic encryption, which makes the encrypted and the decrypted electronic documents playable in the same output unit. This encryption has demonstrated a mechanism, of how audio or video can be distributed within an open file sharing infrastructure. The disclosure describes how protected content is distributed by means of semantic encryption while outnumbering unprotected content by means of content signature or content-specific fingerprints, which correspond to key data that could be received from a distributed key or transaction server, and that, could be presented to end users. The disclosed technology is, with respect to the protection of open and not inherently protectable file formats such as MP3, technically fully operative and efficient. With the centralized or server-sided storage of keys, an elegant opportunity for the commercialization of content is created.

A disadvantage of this invention and every other protected distribution of content consists therein, that the protection and distribution technologies don't support the finding of content by the user. On the contrary, a technology that is particularly suitable for protected mass distribution of content, in particular by means of different keys, and which therefore cannot be utilized with conventional Internet search engines, is leading to the following effect: the more content that is distributed and the larger the variety of the content from different genres and artists, the more difficult it will become for the user to find content with respect to content that is important, interesting, relevant and in an acceptable audio or video output quality. Consequently, the problem is shifting from a distribution problem to a navigation problem. As a solution for the navigation problem, the technology WO 01/30080 A1 is not suitable. The protected distribution is not solving the problem because it is not important how fast, broad, efficient or protected the content is when it is transferred to a single user. Therefore, any other DRM solution is only of limited use in this context.

The more a technology such as WO 01/30080 A1 becomes relevant for the content protection, the more the problem arises that customers will be flooded with documents, about which they don't know anything, in particular, which download links they should execute, which documents they should receive or play, or which they should even purchase.

Because the protected mass distribution via P2P network leads to a non-transparent content pool, the user has no chance or means for a user-sided navigation within this content pool. Therefore, this situation will create an offer similar to the one of MP3.com in which an abundance of content, for which the user is not able to get orientation or navigation. Neutral or trusted recommendations, such as which content is good (i.e., 3^{rd} party valuations or ratings) and how this content can be found (selection) has not been solved by means of the disclosed appliances. On the contrary, the valuation, or rating and selection must be done outside of these described Internet-based distribution processes, which favor the commercial utilization of major label artists and content because of their additional promotion. The distribution of content from unknown artists by means of protected mass distribution is therefore the exception.

An additional disadvantage is the enforcement, or broad usage, of appliances for the copy-protected distribution prior to the commercializing of free file formats, such as MP3. There is immediately the suspicion that the described technology is used mainly to eliminate the content and so a leveled playing ground is created for all solutions, in particular for DRM-utilizing file formats, in order to increase the significance of unpopular formats such as AAC, MP4 or WMA within the content distribution.

The removal of free content, as proposed by spoofing provider OverPeer, has led to technical counter measures within P2P networks. OverPeer's failure has made it clear that a conversion of P2P networks without active support by its user community and contributing participants is commercially and technically not possible.

Although WO 01/30080 A1 has shown a way to use MP3 for music or video distribution, it has made it clear that aside from protection of the content, a technical solution for the marketing of music or video via the Internet and its implicit promotion of the protected content must be considered as an additional problem that needs to be solved, which was not recognized in WO 01/30080 A1 and therefore has not been solved therein.

The abundance of content, which is shown in the millions of different song files within a large variety of different genres, and which has been made accessible via a substantial content pool to the user, and which is provided in an unreviewable amount of data sources with information about this content, turns the selection process of a user, in particular to select a specific song, into a realty difficult problem, which is insufficiently solved within existing Internet solutions. Due to distribution of an extremely large amount of different documents to a mass audience, a new problem is created: the single user must find out what is interesting or relevant for him and this in view of the fact that the single user is limited in his physical receptivity or capacitance. This problem will become more important, because the individual music user is not consuming music quantitatively, but qualitatively.

Furthermore, the problem of assessment of content quality arises before the content is used, outputted, listened to or viewed by the user. Therein, the perceived reliability of a content/file-related valuation or rating is of crucial importance.

In order to simplify or even enable a user the usage of a very large amount of seemingly equivalent content files, the problem arises that additional information about the content, its quality and its correlation to the user-demanded or desired content needs to be created. In the existing Internet-infrastructure, it is very difficult to receive additional information pertaining to downloaded MP3 music files or MPEG video files. Hence another problem arises: that in a very large content pool, the user loses his interest in the offer if no further data for the navigation of and selection by the user are provided.

Traditionally, in the CD-based world this marketing problem has been solved by labels, which are marketing a star and where they were therefore responsible for the filtering. Then customers are purchasing music, which is pre-filtered by the label. A technology according to WO 01/30080 A1 enables that potentially millions of different content titles were distributed.

There are systems in the Internet, in particular within the context of iTunes, Amazon, etc., which provide valuation or rating within a certain framework. However, this valuation or rating is usually subjective, since it is done by a provider, and therefore the valuation or rating is only trustworthy and suitable on a limited basis. iTunes is a music provider, who provides music in a proprietary, protected AAC format for a server-sided download based on pay-per-track.

The dynamic change, modification or adaptation of transaction rules, such as price or usage right is not intended in an eShop-system such as iTunes. On the contrary, iTunes cannot work as a business model, if the artists or content controllers have direct influence on the distribution manner, and of the corresponding business model. Business models such as that used by iTunes are based on the central filtering of content and the dealing and implementing of conditions within the distribution of content. If iTunes is providing free music within its own marketing or promotion, then this is a decision done by iTunes and not based on influence by artists. The content distributor and the corresponding server and/or business administrator decides whether content is free and not the artist.

Furthermore, a proprietary format (AAC) is used by iTunes, from which it is known that a file or content document is protected. This format is not suitable to be distributed via file sharing platforms.

Because of the single price structure at iTunes, iTunes is not really interested in a qualitative rating of the contents, because an order- and hierarchy system would lead to discrimination against content in the lower segment of the rating. On the other side, the upper rating segment can be used, with respect to the ubiquitous usage of free P2P networks, in an unsuitable manner for hints for the download of free MP3 songs.

Moreover, iTunes is also a system for the distribution of content that is only insignificantly different from the classical model of distribution, as it is supported by the labels or music industry of pre-filtered, condensed, and limited offers, which have been marketed by the owner or the manager of the distribution channel and which are centrally controlled by them. For this reason, iTunes cannot be approached directly by an independent artist. Hence, the problem arises that single-user groups such as small independent labels or independent artists, which don't have the access to this technology and/or don't have the access to the mass media, in order to market their artists separately, are potentially excluded in their usage opportunities.

### DESCRIPTION OF THE INVENTION

The purpose of the present invention is to create an appliance for the protected distribution of electronic document files, in particular in a public electronic data network, e.g., within the Internet, as set forth in the classifying portion of claim 1, in which at the same time:
a flexible and protected mass distribution of electronic documents is provided for the protected usage with commercial opportunities
the distribution is accessible by a very large amount of content providers, without the necessity that they have to operate a large infrastructure with a lot of equipment and/or pursue a large marketing effort via the communication channel, and
the individual music consumer is not flooded or affected by a mass of documents, rather from receive, efficiently and effectively, hints as to which content is important, interesting and relevant for him.

The objective is achieved by the apparatus with the features of claim 1 and the method with the features of claim 20. Moreover, all features that are revealed in the present documents shall be regarded in arbitrary combination as relevant and disclosed for the invention; advantageous development of the invention is described in the related dependent claims.

In a manner according to the invention, the distribution of electronic documents and files is done using a client-server network, in particular the Internet. The electronic document is made available or provided via server-sided file or document server, or via Peer-to-Peer networks, or file sharing platforms for the download via client-sided data processing appliances, or devices such as PCs or the like. An electronic document or file is thereby provided and contained in several or various encrypted versions on these file sharing platforms, whereby the encrypted data share the same or similar name, the same or similar metadata, and in a preferred form of the invention, the same file format as the unencrypted document.

The client-sided document user, in particular a listener or user of music, makes use of an Internet-capable access unit, specifically a browser or a document download unit, in order to open the document locally and make it accessible on the client-sided PC and for playing the electronic file on the PC by means of a playback, output or display unit. Therein, the access unit or playback unit is able to decrypt and play the encrypted content. The access to the key is enabled by a server-sided transaction unit, which stores document file-specific key data and corresponding additional transaction data. The access to the document file-specific key and transaction data is designed in a manner such that a reaction on data by means of the client-sided access unit enables access to the key data. Access to these key data is determined by the transaction data. The key data of the requested electronic document file are supplied by the transaction server and are transferred or transmitted to the client-sided access unit. After the reception of key data, a decryption of the document file is possible.

For the electronic document file, additional document file-specific data, i.e. first additional data, are inserted by the document offerer, whereby these additional data are stored on a server-sided additional data server unit, in particular in a server-sided storage or data unit. The input and transmission of additional document file-specific additional data is done via client-sided software, which is provided by content provider or content controller or content creator, in particular via the artist or his/her agent or management, of the electronic document file, which is then transmitted via the Internet on the server-sided storage unit, and thereon stored and managed. These additional data are then assigned on the server-side to the different or various versions of the encrypted electronic document file. These first additional data, such as name of the artist, title and description of the content, belonging to a genre or content category and the like, simplifies the textual finding by means of a search machine and navigation within a category hierarchy via the user. These first additional data are not representing independent ordering or ratings data related to the quality and popularity of the content.

For the same document file, document file specific second additional data, which are stored and managed in a second server-sided additional data server unit or storage or data unit, are generated via the usage of the content by document user, which are different from the document file specific document provider. The extra or further second additional data rate, or assess, the content of the document file directly via the user-sided attachment of rating or assessing comments, or category-related valuation or rating, for example points, or the number of stars or the like, or the indirect rating via the quantity or frequency of usage of the content, or the insertion of the content in a play list, or the like. These document-specific second additional data are, by means of a client-sided means and/or by means of client-sided usage data, stored on a prepared server, in particular as backup data, and the client- or server-sided prepared, processed or transformed data are stored in the second additional data server unit. These second additional data also contains comparison data, such as relation or coupling values between two or more document files and the like. With the usage of these second additional data the user receives, before he uses, listens or views a document, decision-making support. The gained information, which is generated by means of previous usage, represents information which the document provider alone, i.e., without technical measures of the present invention, is not able to create.

The first and/or second additional data can be provided by a Web server and can be displayed via an Internet-capable Web browser.

According to the invention, the document user receives during the playing or output of the electronic document file in the client-sided playback unit extra or further first and second additional data by means of the client-sided additional data unit, whereby in particular the first additional data are related to the content that is outputted in the playback unit, and, in particular the second additional data together with a sub set of the first additional data is related to the not-outputted document files. The first and second additional data are thereby providing data that support the document user before use with decision-making support data within the selection of content and during the usage of content with the opportunity for an improved or deepened experience with the content, or the opportunity to get or find similar content within a very large amount of document files. In order to provide content providers the opportunity to distribute, in particular, unknown content, or to promote unknown artists the marketing of the digital content can be adapted to the status of the artist or to the popularity of the content. This adaptation of the product in this case, for digital content, can be done by means of price or by means of a bundling of digital content with other products, services or even advertising or promotion so that in an extreme case, in the spirit of promotion, for a content file or for an unknown artist, the content usage can be optionally provided for free.

In order to receive for an artist, content provider or content controller, a favorite rating within the second additional data, he must be in the position to change the client-sided transaction data for a document file.

Therefore, the opportunity arises to create a synergetic relationship between content providers, in which content providers have the opportunity to control or manage the content independent of other distribution channels by means of incentives and the document user receives improved recommendations on the basis of these second additional data.

By means of these features or attributes, the solution, according to the invention, is capable of creating and operating a platform or an infrastructure, which provides, besides the protected transmission of digital content, the beneficial effects such as content selection, content rating, filtering of content, and creation and supplying of data for user navigation.

In particular, the solution according to the invention is capable to use the Internet in a manner so that content can be promoted, and at the same time, the content can get a status of independent recommendation, which can only be controlled in a limited manner by the artist, content providers and content server operator.

In addition to mass distribution via P2P network, according to the invention, additional user feedback mechanisms can be used by the document user, so that for the single artist or content provider, their marketing effort can be adapted to the feedback of the fan group or to the content user individually, so that the offer and supply can be adapted to the current market situation, or to the status of the artist, and/or can be arranged by him. This adjustment or adaptation is an advantage, because artists pass through different stages of marketability of their product within their career, and a simple and fast adoption to these market circumstances is therefore beneficial. Therein the realization of a flexible pricing is important, in particular with respect to the utilization of popularity and success, or the usage of gift certificates or vouchers or the promotion or sponsoring of content by ads for the creation of popularity and success as part of this solution.

In the solution according to the invention, the protected mass distribution is supplemented by additional features and mechanisms, so that additional value for the participants, in particular artists, content providers and content users can be created.

Because artists and content offerers are interested in their content finding listeners, and they are in particular interested to have influence on how their content is used, and to which conditions and in which advertising- and/or sponsorship context their content is used, artists have now, by means of using and forming of parallel Internet marketing measures, the opportunity to promote their content in a more targeted way, so that they have the opportunity within their own measures to create a hit. This might be done via a pure advertising-financed success, in which the revenue will come from content of the assigned advertising, or completely free, in which the artist has decided to use the unused promotion to point users to his remaining content.

Thereby the solution according to the invention creates a supply platform, which can be used by the document provider directly for the publication of content to its audience, listener or viewer, which enables a corresponding financial compensation. In particular, unknown artists thereby the opportunity to market their content by means of the supply platform according to the invention, and to turn it into financial revenues.

Because the customer or content user is interested in listening to music undisturbed, and furthermore, to transfer the unprotected content in an unrestricted manner, i.e., with no DRM restrictions or further content-inherent protection measures, to other external media playback units and play it accordingly, the present invention is capable to turn protected into unprotected content without contributing to the devaluation of the corresponding content by means of the uncontrolled distribution of the exported files.

The present inventive solution is capable to be used with technical means for functions such as marketing or promotion which are realized with technical means and can thereby create flexibilization and simplification. Additionally, these functions are taken out of the control of the labels, and can be assigned more directly with technical means to the commercial usage of the content and the actual value-creating activities of the artists. Furthermore, artists or document providers can decide by themselves about the usage conditions.

Via usage of technical means, according to the invention, a structure can be created, in which the various stakeholders such as artists, content controllers, labels and content users are coming together in a synergetic manner on a platform on the basis of generally known standards, in which the advantages of open technologies, such as MP3 or P2P, can be used without creating the impression that it is proprietary.

Furthermore, in favor of the document provider and the document user, it is possible, that only authorized electronic documents can be used, in which the offer of protected content can be acquired by purchase, subscription or advertising, whereby the necessity for legal motions for copyright infringement against document users, in particular against file sharers, can become obsolete.

In a concrete embodiment, the first or second additional data are in a data and/or file format that is different from the electronic document file.

In a further concrete embodiment of the invention, the transaction data can be changed in a document-specific manner by the document file-specific document provider via client-sided input means. Additionally, on the server side, a server-sided transaction data modification unit can made be available, which can be configured by the document file-specific document offerer for a document file, so that this modification unit can modify the transaction data automatically and/or according to predetermined rules.

In a further concrete embodiment of the invention, the client-sided playback unit consists of an Internet-Protocol (IP-) capable media playback unit, in particular, of a media player or a media playback unit, which by means of a software extension such as a Plug-In extended by Internet-capabilities, or which by means of the operating system was extended by Internet capabilities, so that the media playback unit can exchange data for the release of the document file with the server-sided transaction server over the Internet. Thereby the Internet-capable playback unit data receives from the transaction unit, such as e.g. key data or data for the description of the usage data, certificates for the usage of the document file and other document data by means of voucher or subscription-equivalent data. The playback unit can store the received data in a corresponding or associated means of client-sided data storage for use in an offline situation. The client-sided stored data can be used for the decryption of document files or for the visualization/output/representation of additional information during the output or displaying. The client-sided data storage means is a file system or a database.

In a further concrete embodiment of the invention, the server-sided transaction unit contains a database server unit in which the keys for the encrypted document files can be managed and can be used as supplies for the client. This unit or server-sided service is also called the key server. Alternatively, the outputting of the key is done by a predetermined algorithmic method. The access to the key can also be controlled by a prearranged access unit, in which the usage rights are validated.

The payment or transaction for the implementation or realization of a payment process, in particular, a payment via Internet or payment of subscriptions is done by a payment server unit. Alternatively, a server can also create digital vouchers in the form of certificate data, made available to the user and provided to the key access unit for a decision, if by means of certificate data the key for a document file can be released.

The access server or server-sided key access unit can also record, register or determine client-sided usage rights for the document access or comparison with data of the content user or content offerer, or the server unit for the management of the usage rights for the document access of document users can operate separately from the access server. This unit or server-sided service is also called the usage right server.

In a further concrete embodiment of the invention, the client-sided software is used for the transfer or transmitting or uploading of electronic document files by the document provider to a document server unit by means of client-sided software. The software can be an Internet-capable Web browser or an Internet-capable media player or the like. Alternatively, an FTP client system, or a media editor system, or a file sharing System such as a Peer-2-Peer system, or the like, or an instant messenger system, or means for the transmission of data by means of a data carrier or medium can also be used to transfer data to the server-sided document unit.

Additionally, in a further embodiment of the invention, the document file-specific first additional data can by means of a client-sided Internet-Protocol (IP) processing input unit be inserted and transmitted to a corresponding or associated server-sided storage unit and can be stored therein. Besides proprietary software, an Internet-capable Web browser can be used for the input and transmission of data to the server.

The document file-specific first additional data, which are inserted by the document provider, comprise data which are related to content-related relationships to the corresponding or associated electronic document files. They could be selected from the following group of data: text data, image data, audio data, video data, link data, and metadata or data relations between electronic document files or to the document creators or the document providers. Moreover, these data can contain further information about the artist, about the musicians, about the band members, about the album, and about the song in particular. The data for a song, for an artist or musician, or for an album are described as discography data. They also contain information such as genre, categories or the like. Furthermore, the additional data can also contain data related to personal background of the artist or background information to his/her motivation or to the text of the song or the music notes or links to a karaoke version or links to the corresponding music video or to other alternative versions such as an extended or shortened or reduced content version. Furthermore, current data such as calendar or tour data or news or the like data can be additional data.

In a further concrete embodiment of the invention, document file-specific second additional data are data about the output, such as frequency or number of plays or the amount of repeated plays or the number or amount of usages of content in different play lists, or the comparison of average usage or duration of the content in a play list in comparison with other comparable content, or the like, that is stored or managed on the server-sided additional data storage unit of different or various document users. Via the rating means, additional input for the valuation or rating data or via the data about the usage of the content by the content user can be extracted as valuable information for other potential document users. For increasing the trustworthiness of this information, the second additional data are only taken from document users, which are not the corresponding document providers. A further opportunity for the generation of the second additional data consists in the usage of data, which results from the recommendation of or from the rating by a group of experts within an online community, or a member whose judgment has weight and is particularly important because of their competence or prestige or image. In this context, information from artist contests, such as best song or best artist or the like, can be used to create second additional data.

The document file-specific second additional data can be processed by means of a variety of methods. The electronic document can receive a rating, ordering or hierarchy data, with respect to other documents so that the document receives an assigned number, allowing a comparison with other documents. This number or value enables a sequential ordering of the documents. This ordering, which also called document filecentric is ordering or hierarchy scheme can be related to all provided documents or on a subset or set, which is defined by a category or by a common feature. Also a plurality of instructions, based on different valuation or ratings and/or combinations of valuations or ratings or a variety of different metrics, which are applied on single values, could be defined or specified as document file-specific second additional data.

For the different users, different but adapted, rating, ordering or hierarchy schemes can be created or calculated based on individual preferences. The calculation or processing of these document user-centric ordering or hierarchy data is done by means of client- or server-sided generated, stored and/or managed user profile or preference data. With regard to a document provider, document provider-centric ordering or hierarchy data can be generated based on the feedback by document users, which can create for a document provider, e.g., a hit list or the like.

These first and second additional data could be displayed on the client-side by means of a Plug-In in device or output unit that is in an Internet-Protocol (IP-) capable audio/video playback unit, such as is contained in a media player, whereby the output unit is preferably an additional or supplementary Web-based output unit, such that hyperlinks which are contained in the additional data can be directly activated without being redirected through the Plug-In.

The Plug-In can calculate or process the content signature data or content fingerprint data from the electronic document files by means of a client-sided signature unit, whereby these data can be used, to uniquely identify the content. Because the signature unit is using a calculation or processing method, that is used in the same way also for the calculation of the corresponding content data for the server-sided storage of the fingerprint data, they are used also in relation with the extra, supplemental or further additional data, which can, in a request by means of the content fingerprint to extract extra, supplemental or further additional data from the storage unit, in particular from the server-sided transaction unit and/or the first and/or second additional data server unit, be transferred to the client-sided unit. Because of the unique content signature data, synchronization or combination of distributed data records to a content file can be done by means of a content fingerprint.

The algorithm for the calculation or processing of the content signature data consists of reading operations, which by means of algorithmically predetermined data positions, read data from an encrypted document and the data converted via unique instructions in a data-based content signature. Thereby each file is converted with near certain likelihood to a different signature.

The usage of content signature data has in opposite to the content inserted or included data or metadata, such as tags or unique identifiers, the advantage that the management of additional data via the centralized registration of these data, a scarce resource is created, in which ownership can be valuable, because these data are also related to value-creating processes such as advertising, promotion or sponsorship or the like for the owner which can be connected with revenue. The ownership or possession of fingerprint data or equivalent content registration data can be connected or combined with the right to assign with the attachment of first additional data, to the corresponding content. This right can by means of licensing or rights transfer, be transferred to a person or organization, whereby the rights which are related to the content possession remain untouched.

With the calculation, processing and management of the assignment of content signature data to decrypted electronic document files, a key file can be assigned to the encrypted electronic document file, and on the client-side it can be transformed or converted and stored in an un-encrypted document, whereby the access protection can be guaranteed by means of the access unit, the fingerprint data and the additional data associated to the encrypted document file can be displayed on the un-encrypted document.

In a further preferred embodiment of the invention, the transaction server can comprise a server redirection unit by means that client-sided requests can be redirected to another server, such that the management of the first and/or second additional data and/or the key data and/or the corresponding eCommerce services can be processed or executed on another computer remotely and/or logistically separated.

In a preferred embodiment of the invention, an encrypted document file is encrypted by means of a semantic encryption method in which the file structure of an encrypted document is similar or the same of an un-encrypted document. The semantic encryption method is based on the principle that the encryption of the electronic document file is done by the following operations: exchange and/or insertion of the data package, and/or attaching of the data package to a predetermined position in a sequence of the data package, and/or replacing of the data package with a data package that was originally not included in the electronic document, whereby a data package is thereby defined, as consisting of or representing a set of data, so that a change of the data package can be modified by another equivalent data package that does not change the structure of the electronic document file. A further beneficial feature or attribute of the semantic encryption consists of, that the encrypted electronic document file is built in a manner so that its structure corresponds to its un-encrypted form.

Semantic-encrypted data can then be distributed in file sharing (P2P) networks and cannot be differentiated by users of P2P network from unprotected data.

Definition

Within the framework of the disclosure, the following definitions are understood in the following manner:

The electronic document or document files, meaning also files or streams, are interpreted in the following also as texts, images, music, videos, animations or software-based applications, on the document server unit or document server unit, which are realized on one hand via application server or via file server, database server or Web server or on the other hand by means of Peer-to-Peer (P2P) networks or by means of a file sharing or document carrier exchange by means of a client computer, which is called or accessed in a known manner.

In the present application, document server unit is defined broadly, including every type of P2P network, capable of document data exchange and also every type of document carrier exchange, which is capable to exchange document data. The electronic documents, which are displayed on the client, can also be stored locally or by means of data transmission from an external server or data storage via a network for the visualization, outputting or displaying on the client.

The transfer of data is done via the electronic network with established standardized communication protocols such as TCP-IP, UDP, HTTP, FTP or the like. Alternatively, the transmission can also be done via a unidirectional broadcast system. The electronic document is outputted in the document visualization output or display unit or in other digital visual, video- or audio-visualization, output or display unit, as well as displayed, outputted or played in a suitable program runtime environment. The document visualization, output or display unit is in a preferred embodiment an Internet-capable Web browser, an audio-visual media player, a content editor or a player which is realized by hardware.

A client is designated as a computer program or a computer, PC or the like, which by means of a communication line to server resources, is using data or services from a server. The server or server process is located on anther computer as the client, which is then called client server principal or client server network. The client is then responsible for the initial contact within a data transmission and determines its point in time. A client within the framework of the invention is in particular also understood as a conventional personal computer (PC), notebook, PDA, cell phone with user-sided input and visual and audio output or another type of Internet-capable hardware device. A server can consist of one computer or of a plurality of computers, which provide a common service to a client computer. The single computer of the server can be centralized or distributed.

Comparison data are grouped logically in information units, which are transmitted between computer systems or stored on computer systems, and which are created by applying an ordering and hierarchy schema.

A file format or file type determines the form of storing of computer data. With the one-dimensional line-up of bytes in files, the file format conventions are interpreted by the operating system as a representation of a complex data structure. The totality of conventions related to one “kind” of file is then called a file format.

A playback unit is a software program on a client-sided data processing appliance that is analyzing a digital electronic document in a predetermined manner and converts it in audio- and video data, which are outputted or displayed in the output unit. The playback unit can also be realized as a pure hardware solution.

A document provider or offerer is a person that is providing an electronic document to another user for usage. The document provider can be in direct relation to a direct commercial transaction, or in an indirect commercial transaction by means of an eShop or a subscription provider or the like. In particular, the document provider is the creator, producer, causer or creator of the document, or the owner of the document or the licensee, who is legitimized by the copyright laws, or who has by means of an agreement with the creator or owner of the document, the right to exercise transactions.

The document user is a person, who uses, views or listens to a document on the local computer, i.e., the computer which is used by this user. The document user is receiving usage rights or usage conditions, which relate to the kind or manner of usage, such as playing, executing, outputting, printing, storing, copying, transferring, lending, renting, extracting, modifying, inserting and/or exporting to or on a different device, and relate to the time duration of the usage and/or on the amount of usages, or relate to the kind or manner of usage, and/or relate to the usage fee, and/or relate to the usage or application of usage incentives, such as for a certain time or free in the context with advertising or the like.

A virtual community or online community is and/or consists of a group of people, which by means of information technologies, in particular by means of the Internet, are in interaction, communication, meeting or encounter and exchange, in contact with each other directly or by means of a phone and/or in person. The online community is enabled by a special dedicated Web page or Web platform, which by means of known tools, such as e-mail, chat or the like, enables a communication between the members.

### BRIEF DESCRIPTION OF THE DRAWINGS

Further advantages, features and details of the invention will be apparent from the following descriptions of preferred embodiments and with references to the following drawings:

FIG. 1: a schematic block diagram of the system for the protected distribution of electronic document files according to a first preferred embodiment

FIG. 2: a schematic flow diagram that describes in a concrete sequence, a method for the publication of electronic documents via the content provider as shown by the appliance according to the invention, in particular the system as shown in FIG. 1

FIG. 3: a schematic flow diagram that describes a concrete sequence for the modification of document-related additional data or transaction data by the content provider, as shown by the appliance according to the invention, in particular the system as shown in FIG. 1

FIG. 4: a schematic flow diagram that describes a concrete sequence for the usage by the document user, as shown by the appliance according to the invention, in particular the system as shown in FIG. 1

FIG. 5: a schematic flow diagram that describes a concrete sequence for the creation of second additional data by the content user, as shown by the appliance according to the invention, in particular the system as shown in FIG. 1

FIG. 6: a schematic block diagram shows the visualization, output or display unit for the output of first and/or second additional data according to a preferred embodiment.

### DETAILED DESCRIPTION OF THE INVENTION

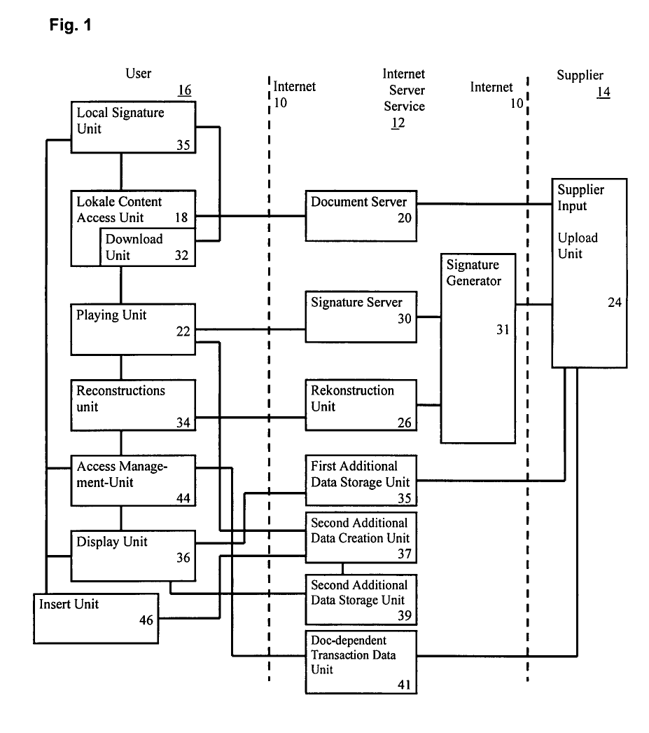

FIG. 1 graphically displays a system separated by means of a symbolic delimiter (10), a publicly accessible electronic data network, which is in the present case the Internet, which is an Internet-server service designated system (12), of a provider (14), in the present case a document provider, which is offering or providing electronically a digital audio document, which will be distributed via the offering system (12). A client-sided user (16), which by means of a symbolically displayed access unit (18) (usually by means of conventional Internet access software equipped computer unit) is accessing in a known manner via the electronic data network (10) a document, which is accessible and/or available via the document server unit (20), where the document server also includes a P2P network. This is done by the generally available, conventional Internet-Protocol (IP), such as e.g. TCP-IP, HTTP or FTP, whereby the document server unit (20) comprises a client-sided means for the visualization, output, or output of a selection of different or various electronic documents (1) by means of the local access unit (18). The client-sided software (32), such as P2P or FTP client, enables the download of a selected electronic file.

Therefore, they are conventional technologies from the state of the art, which do not need any further explanation.

The document, provided within the present embodiment, is or is regarded as a so-called sound or music file, which is created according to the MP3 file format and is played via a suitable playing or output unit (22), which is in particular in a preferred manner part of the user-sided access unit (18) or which is associated to it. The playing unit is suitable to read the MP3 file format and is transforming it into sound signals or music; and is known in the state of the art technology sufficiently well. The file format is sufficiently known as well.

According to the present invention, an uploaded MP3 sound file is stored on the document server unit (20), and supplied for the access by the user (16) and is encrypted on the document server unit (20) by the provider (14), by means of an encryption unit, which is contained in the unit (24) or in the unit (15).

More precisely the encryption consists of operations in which single individual frames for the MP3 file structure are exchanged in a manner that is not according to the corresponding sequence of the original music signal, and/or frames are removed, and/or additional, meaningless frames are inserted and/or frames of two or more independent sound files are exchange or mixed, whereby such encryption manipulation—in the following also called semantic or stealth encryption—, conserves the actual structure of the MP3 format, primarily its header and its corresponding frames. In other words, the playing/output unit (22) (as also every player or viewer unit other, suitable for MP3) opens and plays the encrypted MP3 file. Through the carried out manipulation the created, and from the MP3 retransformed signal doesn't make any sense for the user, because the exchanging, re-placing, removing and adding or inserting of frames in the original sound signal creates a strange result or output that the original music track or the like content of the MP3 file is not useful for a user anymore.

In an advantageous manner according to the invention the provider (14) executes or performs the uploading of the encrypted MP3 file to the document server unit or P2P network or file sharing network (20) in the described manner, so that there is not only one encrypted version of the MP3 file, but also these appears a plurality, e.g. 20, 50 or 100 modestly different encrypted versions of the same music track. Because the document server unit (20), with its table of contents or a not further explained search engine, which is assigned to the provided files, is not making the circumstances of encryption transparent, as the MP3 format remains the same for the encrypted files.

According to the invention the number of files in the file sharing network that are original and not protected versions can be significantly smaller than the number of protected file versions, which comprise the same title, file names, file extension and metadata.

With the described measures within in the framework of the invention, such document server unit or P2P network, by means of a plurality of—from the users view without further intervention not usable—MP3 files is flooded, so that the probability that a user is loading a not-encrypted (and in this way usable without problems) music file is rather small. Due to this circumstance, it can be expected that the user, frustrated by the negative results of opening of downloaded, encrypted music files (for which download is currently, for usual file volume, in the range of between 2 and 4 MB for a typical music tracks of the popular music) becomes demotivated and in the future uses electronic files only by means of the usage of a plug-in software component (5), which the user has to download and to install.

The plug-in software component (5) is in a preferred manner a component, which is contained in the playing/output unit (22) or which is activated in the playing of a document file within the playing/output unit (22). The unit (5) contains a local signature unit (35), which transforms the data of or related to the audio document file (1) into a unique string. The content signatures are assigned on the server side by means of the signature server unit (30) to additional data, which are received on the client side.

The plug-in receives the data from the signature server unit and requests by means of the data that is contained in the received data further server-sided information, in particular the server-sided first additional data units (35) and second additional data unit (39) and transaction data storage unit (41).

If the client-sided stored, or managed access management unit (44), which comprises a means of access to a storage unit, in which additional data, key data or usage right data are stored, which contains server-sided transaction data, the duration of the playing of the content (1) is determined and the playing/output unit (22) is turning after the predetermined duration either in the pause mode, stop mode or plays the protected or unprotected content without interruption. According to the usage right data, the key data are used in the client-sided decryption unit and transferred for outputting in the playing/output unit.

The software component (5) contains also a visualization/output/representation unit (36) for the visualization, representation and output of first and second additional data, which are received by the server-sided first additional data unit (35) and second additional data unit (39).

Additionally, the software components (5) contain the means (46) for the manual creation of second additional data and for the automated creation of data for the usage of a document file (1). These usage data can consist of the frequency of usages or from the usage of files within the play lists or in the storing as favorite artist or song or a client-sided rating or in the valuation message to other users.

Thru a further measure within the framework of the present invention it can be achieved, that not only the described effect of a further distribution of unauthorized music files (and of course also other electronic document files) can be stopped or prevented or at least reduced, but the user (16) is given the opportunity, to transform the downloaded encrypted MP3 document, received from the document server unit (20), in an unencrypted version, so that he, is by means of the P2P software, turned into a legal (and from the view of the provider (14) a potential revenue generating) user, because the content signature of the unprotected document, managed in the same way on the server side, and within a wide distribution of the plug-in, the output of the unprotected document can be made dependent from the access management unit and server-sided transaction data (key, usage rights) within a commercial transaction.

The document provider (14), which is encrypting its MP3 files in the described manner via the encryption unit, which is either contained in the unit (24) or (31), encrypted and stored on the document server unit (20) of the supply server (12), is creating with the encrypted form of the file a corresponding reconstruction file, i.e. key file, which contains the necessary instructions, in order to reset the exchanged, interchanged or replaced frames within the MP3 file in the original form. Such a reconstruction file that is corresponding to an individually encrypted MP3-file is stored on a reconstruction server unit (26) which is also available via Internet.

A logical linkage (and thereby identification—and accessibility of the reconstruction file for an MP3 sound file) is achieved by means of a so-called content signature or fingerprint data record that is calculated or processed from an encrypted MP3 sound file, i.e. a mathematical algorithm is applied on the encrypted file, and results in a signature in the form of a character string or a file, which is characteristic for the content and sequence of the content components of the encrypted MP3 files. A state of the art algorithm is the message digest algorithm MD5 or SHA (secure hash algorithm). The signature is calculated or processed by means of a signature unit (31) on the provider side (14) or calculated or processed within or via the Internet service, and is transferred to the signature server unit(30) which is placed or is made available in the supply server (12) as well, so that a used database, which is designed to be requested by a user, contains or provides a concordance table of a (usually unique) linkage and/or relationship between a signature of an encrypted MP3 document and the name and the location, context (e.g. via a link) to a corresponding reconstruction file and/or additional information, such as first and second additional data and transaction data.

The document provider can, by means of the client-sided input unit (24), which is preferably a Web browser, transfer content to the document server (20) and/or by means of a client-sided or server-sided signature creation unit (31) encrypt the content. Additionally, on the signature creation unit (31), the signature data for the different or various encrypted files and/or un-encrypted document files are created and stored on the signature-server, whereby the corresponding key is stored on the reconstruction storage unit (26). The input unit (24) is using suitable additional document-specific (first) additional data, which contains data related to the artist, to the song, to the album or the like, to capture, gather or register and to transfer it to the first additional data storage unit for its storage. Additional transaction data can also contain or define or modify data such as price, kind of usage or the like by means of the input unit (24) and can be stored in the server-sided transaction data unit.

FIG. 2 describes a schematic flow diagram, which shows or describes a concrete workflow for the publication of electronic documents by the content offerer or provider. In the process step (S5) an electronic document is chosen, picked or selected by a document provider (14). This selection can, in a preferred manner, be done within or by means of Web browser. The documents are then manually inserted by the document provider in step (S10) with first additional data such as text, links, images or discography for the artist, musician, or album. Additionally, the transaction data are determined or are selected from an existing list. In a further process step (S15), the electronic document file (1) is taken or transferred from the document server (20) and/or the signature creation unit (31). In the process step (S20) the electronic files are encrypted in the signature generation- or creation unit (31) and the corresponding signature data (15) are created for the encrypted and unencrypted electronic file (1). In the process step (25), the inserted first additional data are transferred and stored in the first additional data storage unit (28), so that an assignment to the corresponding signature data means of the unit (28) is possible. In the process step (S30) the inserted transaction data are transferred and stored in the transaction data storage unit (41), so that an assignment or correlation to the corresponding signature data by means of the unit (41) can be made possible.

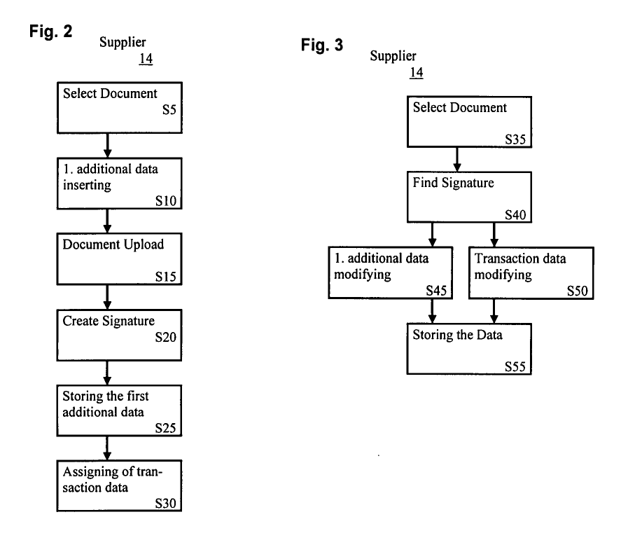

FIG. 3 describes a schematic flow diagram, which shows a concrete workflow of changes of document-related additional data or transaction data via the content offerer or provider. In the process step (S35) an electronic document is chosen, picked or selected by a document provider (14). This selection can in a preferred manner been done within or by means of a Web browser. In the process step (S40) signature data are found for the selected document, so that the corresponding data by means of data requests of document specific first additional data server (28) and/or transaction data server (39) are extracted and transferred to the input unit (24). In the process step (S45), the first additional data are modified and/or in the process step (S50) the inputted transaction data are modified by the provider (14). In the process step (S55) the modified are finally transferred and stored to the first additional data storage unit (28) or transaction data storage unit (41).

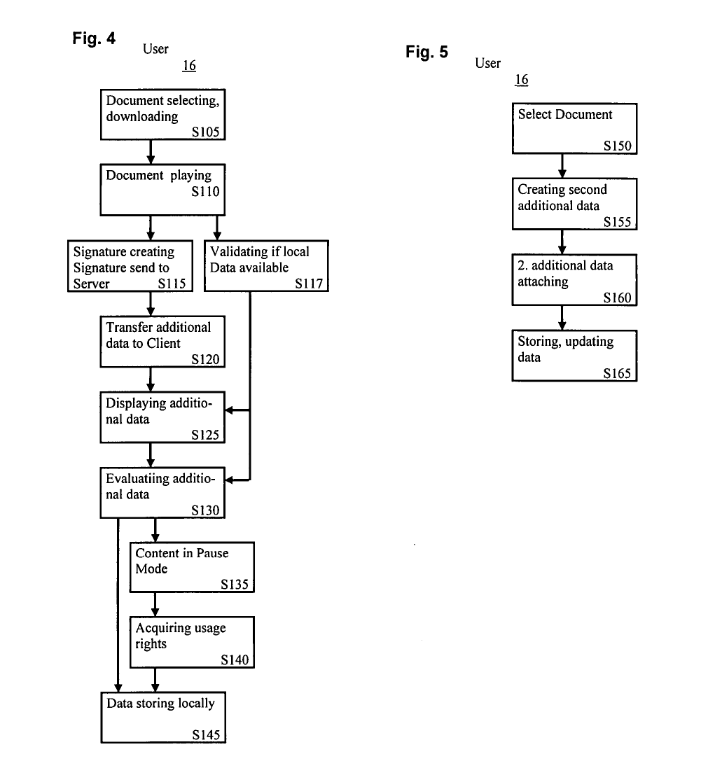

FIG. 4 describes a schematic flow diagram that shows in a concrete workflow the usage of an electronic document by the document user. In the process step (S105), an electronic document (1) is chosen, picked or selected by a document user (16) and/or in a previous or following process step, is downloaded from the document server (20) by means of client-sided software (32). Subsequently, by means of the activation of the playing/output unit, in the process step (S110), in which the electronic document (1) is outputted in the playing/output unit (22), data for the creation or generation of content signature are extracted from the content (1) by means of the client-sided signature unit (35). In the process step (S115) the signature data are created and transferred to the Server (12) and in the process step (S117) signature data are used in order to validate the local access management unit (44), which comprise a data management of already received additional data and/or key and/or transaction data, whether document specific data are already available on the client-side and could be displayed and/or evaluated. In the subsequent process step (S120), the first and/or second additional data and/or transaction data and/or server address data are transferred to the client and received from the client and/or processed. The first and/or second additional data are then outputted in the process step (S125) in the additional data visualization, output and display unit (36). In the process step (S130) the transaction data or the corresponding data, which are managed or provided by the access management unit as access data or usage right data, are evaluated and/or processed, so that the unit (36) is outputting the content data (36) in the output unit (22) in the case of missing usage rights only the not-encrypted part or after a predetermined time frame stops the outputting or is transferred into the pause mode. In another embodiment the output of encrypted content can occur.

In the process step (S135) according to the transactions data, the output unit (22) is transferred within the output of the document (1) in the pause mode. In the process step (S140), the user can in this pause mode acquire the content by means of a transaction. The data in the visualization/output/representation unit (36) provide hints on the opportunity to purchase or acquire usage rights for the content. By means of activating an input means e.g. a button for the purchase of the document or a subscription via mouse a usage right on the content can be acquired. In the visualization, output or displaying unit, data from the document dependent transaction data unit are also used, in order to communicate to the potential user the condition and to enable him the acquisition by means of a transaction. The user then receives certificate data, which then in a further data communication step are exchanged for a key by the key storage unit (26) and are transferred to the client. In the subsequent process step (S145) the received data such as additional data, transaction data, in particular key data or usage right data, are stored by the access management unit (44). The playing/output unit can, in the process step (S148), then be turned from the Pause-Modus in Play-Mode or the output of the content can be restarted, if usage rights have been acquired.

FIG. 5 describes a schematic flow diagram, which shows a concrete workflow in the creation of second additional data via the content user. In the process step (S150), an electronic document (1) is chosen, picked or selected by a document user (16) and/or in a preceding or follow-up process step is downloaded from the document server (20) and/or played or outputted. In the process step (S155) either the second additional data are inserted manual by means of predetermined valuation schemata and/or second additional data are created automatically by means of a usage of the content from the favorite lists or play lists. The created second additional data are then received and processed in the process step (S160) by the server-sided second additional data creation unit (37), and as second additional data attached in the second additional data storage unit (39) and stored in the process step (S165) and/or updated and/or provided for the request by a Client.

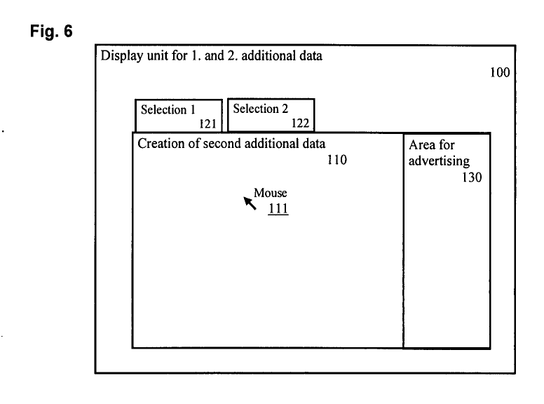

FIG. 6 shows a schematic block diagram of the visualization, output or display for the output of first or second additional data and/or data for the transaction according to a preferred embodiment. The visual output in the visualization/output or display unit (36) for the first and/or second additional data is done within a Web-Browser Interface (100). This interface contains an area (110), in which text, images or hyperlinks according to the selection of the selection means 1 (121) or 2 (122) is displayed, whereby the area (110) displayed data are from first and/or second additional data and/or from data of the transaction unit (41) or from data generated related to the user-specific usage rights. The selection means (121) can be a graphical means for the visualization, output or displaying and usage of first selection means, in particular a hyperlink for the visualization/output or displaying of further additional data within the area (110), or could be a Tabulator or Tab (122) or the like. These selection means, such as the hyperlinks within the area (110) can be activated by a mouse (111).

Within the interface area (110) can also be contained an area (130) which is designed for the output of advertising, in particular product or service information or the like, which data are transferred from the server (12).

### Further Advantages and Embodiments

In a manner according to the invention, the key data for a content, which is characterized by fingerprint data, can be created, managed or provided by the server-sided key server unit.

The encryption is done either in client-sided software or in a server-sided electronic encryption unit, whereby encryption data and the decryption data as well contain data, statements or instructions about the exchanged, permuted, removed, attached, inserted and/or replaced data packages.

The encryption unit of content is done by means of an analysis unit, which analyzes the original electronic document and determines thereby a set of information components from the original document to reaction on the predetermined or extracted or detected format- or structure data from the original document. After the analysis of the document, the manipulation unit is using the following operations: Replacing, exchanging or removing of an information component from the original document or attaching, inserting of an information component in a predetermined position in the sequence of information components or exchange of an information component with another information component which is not contained in the original document as well as creating a key data set as a reconstruction file or instruction file with data or statements about the exchanging, removing, attaching, inserting and/or replacing of information components, in order to enable the reconstruction of the original document.

The client-sided access unit or the playback unit contains a function unit, which can be influenced in a software technical manner by instructions or by elements of a key file. The keys and the instructions combine the encrypted electronic document file together with the corresponding key file and create the original electronic document, that then appear in a usable form or manner.

The server-sided transaction unit can also comprise an electronic assignment unit, which is connected with a database server via the electronic data network, and which is assigned with a key data storage unit to the key server unit, and which creates a common server unit.

The assignment unit can be remote, i.e. spatially separated from the key server, and in particular, enable the connection- and/or link creation by a client-sided request for a plurality of different or various key server units. The redirection of client-sided requests can be made dependent of document specific data or of content-specific fingerprint data.

In a further embodiment of the invention, the key data storage can be assigned to a user identification and/or accounting unit, which is suitable for the capturing, gathering or registering and processing of the user identification data, such as user ID, password, session ID, account or credit card number or the like. This unit is then capable for the execution or implementation of a financial transaction with the user and/or for the assignment or management of the user or user group-specific access rights, in particular by means of certificate data.

The transaction server can create certificate data, which are used by the client-sided access unit for the download of document-specific key data from the server. These certificate data can also be stored on the client side and can be used by the client-sided access unit for a plurality of accesses to document files, as for example for subscription or voucher. The certificate data, which are associated with a subscription, are transferred to a suitable server, validated and a document-specific certificate is created or generated and transferred to the client. By means of these document-specific certificates a document access model can be realized, in which in particular, a paid content access on the electronic document file or on a predetermined set of electronic document files or on an undetermined set of electronic document files can be realized. In particular, a subscription or an unlimited access to a limited set of electronic document files in particular defines by means of a category-specific or genre-specific subscription can be realized by means of the document access models.

Additionally, by means of certificate data the output or play-back of the electronic document file can be realized and made dependent of the visualization, outputting or displaying of additional advertising or promotion via data or information about unrelated third party products or third party objects. This advertising or promotion can, in a predetermined area of the additional data, be displayed in output unit.

The output of electronic content files in the playback unit can be made dependent on the availability of additional or supplemental certificate data and the usage rights that are contained in the certificate data. If these certificate data are not available and the client-sided access unit has received the server-sided transaction server data within a predetermined or received and represented timeframe, then the client-sided access unit or play-back unit can after the output of content for the received time value be interrupted or passed into a pause mode.

The second additional data can, in a further embodiment of the invention, be created by members of a user group. These members of user groups are connected by rules or by common properties or attributes or interests, in particular they could be members of an online community. In this community the second additional data can be created and provided as text data, link lists, category lists, and order- and/or hierarchy data in particular rating data.

Alternatively encrypted document files can also be encrypted by means of a mathematical encryption method and the server-sided key server unit can be suitable for the creation or supply of corresponding keys. The fingerprint data are thereby assigned by the server-sided assignment unit to an address or to a plurality of addresses, which link to servers, which then provide the key data and/or the first and/or second additional data.

Further hints or concrete realizations of the encryption and/or transaction and features can be taken from the disclosure of the application, WO 01/30080 A1, which with respect to the present application can be regarded as entirely included as part of the current invention.

Table of References

The following table contains additional descriptions of the references to FIGS. 1 to 6, and it is part of the present invention and its disclosure.

Reference descriptions are:

| | |
|---|---|
| (1) | Electronic document files, in particular audio-, video- or image data |
| (5) | Software components or plug-ins, which are downloaded by a user and/or in- |
| | stalled and already pre-configured that are already collaborating with the out- |
| | put unit and are performing the output, signature creation, communication with |
| | servers, reconstruction of encrypted document files and the access management |
| (10) | Means for the transmission of electronic data or documents via a network, in |
| | particular by means of the Internet |
| (12) | Server means or server-sided resources, which can be used via clients by means |
| | of the Internet |
| (14) | Provider of documents, which by the server-sided means (12) are supplied to users (16) |
| (15) | Content signature data or content-specific fingerprint data |
| (16) | Document users, who are using or accessing an electronic document (1) by |
| | means of a server-sided means (12) |
| (18) | Client-sided means for the access to content, in particular access to data on |
| | client-sided storage means, and means for the access to documents via the elec- |
| | tronic network (10) |
| (20) | Means for the server-sided storage, transmission and providing of document |
| | files, in particular via file server, P2P networks and peers, which provide data |
| | or the like document server |
| (22) | Means for the client-sided playing or outputting of document files, in particular |
| | audio, video or image files |
| (24) | Means for the provider-sided insertion or inputting of additional data and |
| | means for the provider-sided uploading on server-sided means for the storage |
| | of document files, in particular audio, video or image data on the document |
| | server and means for the input, storage, creation, management or transfer of |
| | content signatures (15) to the server-sided means (31), and means for the input, |
| | modification, storage, creation, generation, management or transfer of addi- |
| | tional data to the server-sided means (28) and means for the input, modifica- |
| | tion, creation, management or transfer of transaction data to the server-sided means (41) |
| (26) | Server-sided means for the storage, creation and/or management of keys for the |
| | decryption of encrypted documents, in particular by means of providing seman- |
| | tic reconstruction data |
| (28) | Server-sided means for the storage, creation, management or transfer of first |
| | additional data, in particular document specific additional data or metadata or |
| | text data or link data related to document data specific additional data |
| (30) | Server-sided means for the storage, creation, management or transfer of content |
| | signature data or content-specific fingerprint data assignment of client-sided |
| | generated signature data to the address for the management and storage of fur- |
| | ther information; means for the document file-specific assignment of additional |
| | server addresses |
| (31) | Means for the creation of content signature data to the electronic document file |
| | and means for the usage of content signature data assignments of signature data |
| | to additional data |
| (32) | Client-sided means for the downloading or storing of electronic document files |
| | in particular, via a P2P or FTP clients |
| (34) | Client-sided means for the reconstruction of electronic document files and/or |
| | for the application of key data on an electronic file and for the supply of de- |
| | crypted data to the local playing/output unit |
| (35) | Client-sided means for the creation, management or transmission of the content |
| | signature, which are created from files, which are managed on the local storage unit |
| (36) | Visualization, output, or displaying unit or means for the output or visualiza- |
| | tion or displaying of first and/or second additional data in particular, a Web |
| | browser for the visualization, output, or displaying of server-sided additional |
| | data, in particular text, images, or links to further additional information |
| (37) | Server-sided means for the creation, preparing and management of second ad- |
| | ditional data, in particular comparison data, ordering or rating and/or hierarchy data |
| (39) | Server-sided means for the storing, creating, management and transmission of |
| | second additional data, in particular document-specific additional data or meta- |
| | data or text data or link data of further document-specific additional data or |
| | comparison data or ordering or rating and/or hierarchy data |
| (41) | Server-sided means for the storing, creating, management and transmission of |
| | transaction data, in particular document-specific prices or usage right data or |
| | data from client-sided usage rights (subscription or the like) or provider-sided |
| | offers (voucher or the like) |
| (44) | Client-sided access management unit or means for the management and/or for |
| | the client-sided output of electronic document files (1) in the playing/ display or |
| | output unit (22) |
| (46) | Client-sided means for the manual creation or for the automatic generation of |
| | document specific second additional data and means for the transmission of |
| | second additional data in the server-sided additional data creation unit (37) |
| (48) | First additional data, which are displayed by the client-sided visualization, out- |
| | put or display unit |
| (50) | Second additional data, which are created by the client-sided playing/output |
| | unit (22), or by the input unit (46) |
| (52) | Second additional data, which are displayed by the client-sided visualization, |
| | output or display unit |
| (100) | Visual output of the visualization, output or representation unit (36) for the first |
| | and/or second additional data |
| (110) | Visual output of text, images, pictures or hyperlinks with respect to the selec- |
| | tion means 1 (121) or 2 (122), whereby the displayed data are generated or |
| | extracted from first or second set of additional data |
| (111) | Graphical input means or mouse for the activation of hyperlinks or the selec- |
| | tion means (121, 122) |
| (121) | Graphical input means for the visualization, output or displaying and usage of a |
| | first selection means in particular a hyperlink to the visualiza- |
| | tion/ output/representation of further additional data in the visual interface (110) |
| (122) | Graphical means for the visualization, output or output and usage of a second |
| | selection means, such as a tabulator tab or the like |
| (130) | Area within the output unit of additional data, which is used for the product- or |
| | service information or the like |
| (S5) | Process step, in which an electronic document is chosen, picked or selected by |
| | a document provider (14) |
| (S10) | Client-sided including or insertion of first additional data or transaction data by |
| | the document provider |
| (S15) | Process step, in which an electronic document file (1) is transferred to the |
| | document server (20) and/or transferred to the signature creation unit |
| (S20) | Process step, in which the signature creation or generation unit (31) creates |
| | signature data (15) for the electronic document (1) |
| (S25) | Process step, in which the first additional data, which are inserted by provider |
| | (14) are stored in the first additional data storage unit (28) |
| (S30) | Process step, in which the transaction data, which are inserted by the provider |
| | (14) are stored in the transaction data storage unit (41) |
| (S35) | Process step, in which an electronic document (1) is chosen, picked or selected |
| | by a document provider (14) |
| (S40) | Process step, in which the signature data, which are available to the selected |
| | document, can be found and can be used for the data request of document- |
| | specific first additional data and transaction data |
| (S45) | Process step, in which the first additional data inserted by the provider (14) are |
| | changed by the provider (14) |
| (S50) | Process step, in which the transaction data inserted by the provider (14) are |
| | changed by the provider (14) |
| (S55) | Process step, in which the changed data are stored in the first additional data |
| | storage unit (28) or transaction data storage unit (41) |
| (S105) | Process step, in which an electronic document (1) is chosen, picked or selected |
| | by a document user (16) and/or downloaded in a previous or following process |
| | step from the document server (20) |
| (S110) | Process step, in which the electronic document (1) is outputted in the play- |
| | ing/output unit (22) and data are extracted from the content for the creation of |
| | the content signature by means of the client- sided signature unit |
| (S115) | Process step, in which the signature data is created and sent to the server (12) |
| (S117) | Process step, in which the signature data is created and validated in a local ac- |
| | cess management unit (44), if content-specific data are available on the client- |
| | side and can be displayed or outputted and/or evaluated or processed |
| (S120) | Process step, in which the first and/or second additional data and/or transaction |
| | data and/or server address data is transferred to the client and received and |
| | processed by the client |
| (S125) | Process step, in which the first and/or second additional data are outputted in |
| | the additional data visualization/output/representation unit (36) |
| (S130) | Process step, in which the transaction data or the corresponding data are proc- |
| | essed, calculated or executed in the access management unit and can thereby be |
| | used, such that the output unit (22) can stop the output, or can be turned into |
| | the pause mode, or into the output of the encrypted content |
| (S135) | Process step, in which the output unit (22) is stopped in the output of the |
| | document (1) or turned into the pause mode or outputted in an encrypted con- |
| | tent file |
| (S140) | Process step, in which the user is offered to acquire the content by means of a |
| | transaction or an activation of an input means (e.g., a button via mouse click), |
| | i.e., a usage right on the content, in which data from the document-dependent |
| | transaction data unit are used, and the user informs or communicates the condi- |
| | tions and thereby enables the acquisition by means of a transaction to gain the |
| | key from the key storage unit (26) |
| (S145) | Process step, in which the received data (additional data, transaction data, in |
| | particular key data or usage right data) of the access management unit are stored |
| (S148) | Process step for the removing of the pause modus or status, or restart of the |
| | contents, if usage right has been acquired |
| (S150) | Process step, in which a electronic document (1) is chosen, picked or selected |
| | by a document provider (16) and/or is downloaded in an previous of following |
| | process step from the document server (20) and/or then played or outputted |
| (S155) | Process step, in which the second additional data are inserted manually and/or |
| | second additional data are generated automatically |
| (S160) | Process step, in which the server-sided second additional data, which are gen- |
| | erated manually or automatically, are received and are processed by the second |
| | additional data creation unit (37) and the second additional data are attached or |
| | added to the second additional data storage unit (39) |
| (S165) | Process step, in which the second additional data are stored and/or updated |
| | and/or supplied for the call be a client |

1. System for the protected distribution of electronic document files via a client server network, in particular the Internet, with
a server-sided document server unit, which is designed to enable a client-sided request on a selected from a plurality of presented encrypted document files from the document server unit,
an access unit that is assigned to a client-sided document user, which is designed for the execution or performing of the data access and for the playback or output of the accessed and encrypted document file by means of a playback or output unit, and
a server-sided transaction unit, which is designed for storage and access on document file specific key and transaction data, so that as a reaction on an access by means of the access unit within a transaction, defined by transaction data, an assignment of key data to a requested electronic document file and a subsequent encrypting of document file is made possible,
characterized by
means of a client-sided transmission of an electronic document file via the client-server network to the document server unit via a document file specific document provider,
means for client-sided inputting of document file specific first additional data in a first server-sided additional server unit by the document file specific document provider, whereby the first additional data comprises a first predetermined additional data structure,
means for client-sided inputting of document file specific second additional data in a second server-sided additional data server unit which are connected via a, with the transaction unit, connected and from the document file specific document provider different user, whereby the second additional data comprises data to a plurality of, on the document server unit stored, document files or comparison data,
means for client-sided requesting of the first and of the second additional data by means of the access unit and for the displaying of the first and/or the second additional data during the playing by the means of the playback unit and
means for client-sided modification of the transaction data.

2. System as set forth in claim 1 characterized in that said additional data comprise a data and/or file format that is different from a data and/or file format of the electronic document file.

3. System as set forth in claim 1 characterized in that said client-sided changing or modification of the transaction data by means of a server-sided transaction data modification unit is done by the document file specific document provider.

4. System as set forth in claim 1 characterized in that said document files comprise a unified file format.

5. System as set forth in claim 1 characterized in that said client-sided document user associated to the playback unit is a Internet-Protocol (IP) capable media playback unit and/or said Internet-Protocol (IP) capable media playback unit comprises a Plug-In, that is exchanging data with the server-sided transaction unit via the Internet and receive data from the transaction unit and store data in a corresponding client-sided data storage means.

6. System as set forth in claim 1 characterized in that said server-sided transaction unit comprises a mean for the management and/or creation or generation of keys of encrypted document files in a key server, and/or comprises a payment or transaction unit for the implementation and execution of a payment process in a payment servers, and/or comprises a mean for the capturing, gathering, registering or determining of usage rights for the document access of document users in a usage right server or access server.

7. System as set forth in claim 1 characterized in that said means for the client-sided transfer of said electronic file via the document provider is a client-sided system for the uploading of said document files or is a Web browser or is a media player system or is an FTP client system or is a media editor system or is a Peer-2-Peer client system or is a file sharing system or is a means for the transfer of data by means of a data carrier or media carrier and/or said client-sided inputting of document file specific first additional data is an Internet-Protocol processing input unit or a Web browser.

8. System as set forth in claim 1 characterized in that said document file specific first additional data comprises the following data, which have a content-related reference to the electronic document files and are selected from the following group, which comprises text data, image data, link data, metadata or relationship data to the electronic document file or to the document creator of the electronic document file or to the document provider of the electronic document file.

9. System as set forth in claim 1 characterized in that said document file specific second additional data are data for the outputting, versioning, utilization, valuation, or application of the electronic document file by the user that is different from the document provider or are data corresponding to an electronic document file centric ordering or hierarchy data in particular rating or reference data or document user-centric ordering or hierarchy data or rating or reference data or a document provider-centric ordering or hierarchy data or rating or reference data.

10. System as set forth in claim 1 characterized in that said means for client-sided requesting of first and second additional data is a plug-in of an Internet-Protocol capable audio/video playback unit, in particular with an additional Web-based output unit.

11. System as set forth in claim 1 characterized in that said electronic document files are uniquely identified by means of a content signature data or content fingerprint data and linked on the server side with the additional data.

12. System as set forth in claim 11 characterized in that said content signature data or said content fingerprint data are transferred from the client-sided access unit of the document user to the server-sided transaction unit and/or to the first and/or second additional data server unit and/or is encrypted by means of a semantic encryption scheme or process and the server-sided key server unit is suitable for the creation or supply of corresponding keys and/or said content signature data is designed for the creation of the data related content signature based on a common algorithm based reading operation that reads algorithmic determined data positions of the encrypted document.

13. System as set forth in claim 1 characterized in that said transaction server comprises a server redirection unit, which redirects the client-sided requesting of the first additional data on the first server-sided additional data server unit and/or the client-sided requesting of the second additional data on the second server-sided additional data server unit and/or the client-sided requesting of the key data on the server-sided key server unit and/or
said transaction server is an electronic encryption unit (24) for the creation or generation of the key data with data, statements or instructions about the exchanged, removed, attached or inserted and/or replaced data packages
and/or said transaction server creates a certificate data record, which can be used by the client-sided access unit to download document specific key data from the server.

14. System as set forth in claim 12 characterized in that said semantic encryption scheme or process is designed that for the encryption of an electronic document file, a document file—containing data package of a document file specific document data structure is executing or operating the following operations or instructions: exchanging and/or removing of the data package and/or attaching or inserting of the data package at a predetermined position within a sequence of data packages and/or replacing of the data package by a data package that is not contained in the original electronic document, or by means of a computer access on corresponding electronic data storage areas of the electronic encryption unit, in which the data package of the corresponding document data or data structure is stored.

15. System as set forth in claim 13 characterized in that said certificate data are stored on the client-side and can be used by the client-sided access unit for a plurality of accesses to the document file and/or
said certificate data are used to create a document access model or create a paid content access to an electronic document file or to a predetermined set or plurality of electronic document files or to an undefined amount of electronic document files or by means of a subscription or an unlimited or unrestricted access on a limited amount of plurality of electronic document files or by means of a category-specific subscription.
said certificate data is dependent on the visualization or output of a plurality of additional data or information about unrelated third party products or objects, or product- or service-related advertising or promotion.

16. System as set forth in claim 14 characterized in that said encryption unit (24) comprises: an analysis unit (54, 56), which is designed for the access on an original data set of the electronic document and for the electronic capturing or registration of at least a sequence of information components of the original data set as reaction on the predetermined and/or examined or determined format and/or structure data of the original data set,
a manipulation unit (64), which is following the analysis unit and which is designed for the
exchanging and/or removing of an information component within the original data set and/or inserting or attaching of an information component to a predetermined position in the sequence of information components and/or replacing an information component by an information component that is not contained in the original data set and for the
creation of a key data set as a reconstruction file with data, statements or instructions about the exchanging, removing, inserting or attaching and/or replacing of information components, which is designed to reconstruct the original data set.

17. System as set forth in claim 15 characterized in that said key data storage unit is assigned to a user identification- and/or payment or accounting unit (38), which is designed for the creation, capturing, or registration of an user identification data, for the execution, performing or implementation of a financial transaction with the user and/or for the assignment or management of user or user group specific access rights.

18. System as set forth in claim 1 characterized in that said encrypted electronic document file is transformed or stored in an in an unencrypted document by the client-sided access unit and/or the playback unit that is assigned to the document user and/or said encrypted electronic document file is built up or set up in a manner so that its structure is the same as the unencrypted form.

19. System as set forth in claim 1 characterized in that said client-sided means for the output of the additional data show or displays a plurality of data about unrelated third party products or objects in a predetermined area.

20. System as set forth in claim 1 characterized in that said playback unit is turned or led the output of the electronic document file to a stop or to stop pause mode if no corresponding certificate data have been received after a predetermined time period from the server-sided transaction server.

21. System as set forth in claim 1 characterized in that said second additional data are created by a member of a user group, which are linked or connected by a predetermined rule, or members of an online community, in which second additional data are created or provided as text data, link lists, category lists, rating and/or hierarchy data and/or said first and/or second additional data are provided by a Web server and displayed by an Internet-capable Web browser.

22. System as set forth in claim 1 characterized in that said encrypted document file which is encrypted by means of a mathematical encryption method and that the server-sided key server unit is suitable to create, generate or provide corresponding keys and/or said encrypted and/or decrypted electronic document files are distributed by means of file sharing and receive and display the first and/or second server-sided additional data by means of the client-sided access unit.

23. Method for the protected distribution of electronic document files via a client-server network or Internet with the client-sided steps:
transfer of an electronic document file to a document server unit via the client server network by a document file specific document user,
inserting of document file specific first additional data to a first server-sided additional data server unit via the document file specific document provider, whereby the first additional data comprises a first predetermined additional data structure,
taking or calling the electronic document file and/or the first additional data by a user that is different from a document file specific document provider
inserting of document file specific second additional data in a second server-sided additional data server unit by a, with the transaction unit, connected user that is different from the document file specific document provider, whereby the second additional data comprise data to a plurality of, in the document server unit stored, document files or comparison data,
fetching the first and the second additional data by means of the access unit, displaying the first and/or the second additional data during the playback or output by the playback or output unit and
modifying the transaction data via a server-sided transaction data modification unit by the document file specific document provider.
